(19) United States
(12) Patent Application Publication
(10) Pub. No.: US 2007/0089790 A1
(43) Pub. Date: Apr. 26, 2007

(54) Assembly for connecting a water supply to heating systems with a water heater

(75) Inventor: Willi Hecking, Niederkruechten-Elmpt (DE)

Correspondence Address: THORPE NORTH & WESTERN, LLP., 8180 SOUTH 700 EAST, SUITE 200, SANDY, UT, 84070, US

(73) Assignee: Hans Sasserath & Co. KG, Korschenbroich (DE)

(21) Appl. No.: 11/586,771

(22) Filed: Oct. 25, 2006

(30) Foreign Application Priority Data
Oct. 25, 2005 (DE) 10 2005 051 348.4

(51) Int. Cl. F16K 11/20

(52) U.S. Cl. 137/597

(57) ABSTRACT

An assembly (10) for feeding water from a water supply into heating systems having a drinking water heater and a heating circulation installation includes a fresh water inlet (14) to be connected to the water supply, a first outlet (16) with a first shut-off valve (32) to be connected to the water heater, and a second outlet (26) with a second shut-off valve (98) to be connected to the heating circulation installation. A differential pressure controlled outlet valve (60) between two backflow preventers (62, 64) forms a system disconnector between the fresh water inlet and the second outlet for physically disconnecting the water supply from the heating circulation installation. This arrangement uses only one fresh water connection to supply both the drinking water heater and the heating circulation installation. Accordingly, the assembly is less voluminous and a separate assembly for filling and re-filling the heating circulation installation is not necessary.

### TECHNICAL FIELD

The invention relates to an assembly for feeding water into heating systems provided with a drinking water heater, comprising a fresh water inlet for the connection with a water supply, a first outlet for the connection with a water heater and shut-off means for shutting off the fresh water inlet.

Drinking water heaters usually are heat-insulated reservoirs. The reservoir is, on one hand, connected to a drinking water system and on the other hand to a house water system. The house water system is provided with tapping points for heated drinking water. The heating of the drinking water is achieved by means of a heat exchanger with hot heating water of a hot water heating system flowing therethrough.

The assembly connects a heating system with a drinking water heater to the water supply. A shut-off valve is provided for servicing or exchanging of the heating system. Therefore, there is no need to completely shut off the entire water supply of a building. Assemblies known in the art for supplying fresh water to a drinking water heater show the disadvantage that the temperature of the tapped warm water depends on the inlet pressure of the fresh water supply. Especially for smaller gas heaters the heating capacity is under certain circumstances not sufficient for large quantities of water. The temperature of the hot water will, therefore, decrease at high pressures.

On the other hand, the heating water is circulated in a seperate, closed circulation installation, i.e. the heating circulation installation. The water is heated, flows to the radiators (forward flow pipe) and emits heat in the radiators. The water will flow back to the heating system through the back flow pipe.

Due to aeration a pressure drop may occur. Then the pressure in the heating circulation installation will decrease. Therefore, the heating circulation installation must be refilled in regular intervals.

### Prior Art

Heating systems known in the art have a fresh water connection in fluid communication with the house water system through an assembly described above. Independently of such a fresh water connection (drinking water system) the filling and re-filling of the heating circulation installation is carried out in a fully separate manner. It must be avoided at all circumstances that water from the heating circulation installation flows back into the drinking water system if, for example, a pressure drop occurs in the drinking water system. There are special safety regulations in place, for example EN 1717.

Filling or re-filling is possible with so called system disconnectors. Such a system disconnector is known, for example, under the commercial name “FüllCombi BA 6628” by the applicant. This is a system with two backflow preventers. They are spring-biased check valves opening under the influence of the drinking water pressure only in the direction from the drinking water system to the heating circulation installation. However, they are not considered as sufficient for constant use. If a pressure drop occurs on the inlet side a physical disconnection is effected between the drinking water system and the heating circulation installation. The system disconnector known in the art substitutes the hose used in old heating systems which was removed after completion of the filling- or re-filling procedure. A differential pressure controlled outlet valve is arranged between the backflow preventers. If the pressure difference between the drinking water system and the heating circulation installation drops below a given value, the outlet valve opens automatically. If the heating circulation installation is filled or re-filled form the drinking water system and there is a sufficient drinking water pressure the outlet valve is closed. Drinking water flows to the heating circulation installation through the backflow preventers which are now pushed open by the drinking water pressure.

The known system disconnector operates semi automatically, i.e. if there is a pressure drop which is displayed at, for example, a pressure gauge, an inlet side shut-off valve must be opened and the filling or re-filling process must be initiated. After completion of the filling process the valve must be manually closed. There are also automatic assemblies, for example known under the mark “reflex ‘fillcontrol’” by Reflex Winkelmann GmbH+Co. KG, Gersteinstrasse 19, D-59227 Ahlen. This assembly is provided with its own pressure sensor monitoring the pressure in the heating circulation installation. The shut-off valve is motor controlled.

The filling fittings known in the art comprise many components and they are voluminous. Therefore, they are installed outside the heating vessel of common heating systems and they are separately connected to the drinking water network by the safety devices fulfilling the legal requirements.

### Disclosure of the Invention

It is an object of the invention to simplify the connection fittings of existing heating vessel designs and make them more compact.

According to the invention this object is achieved with an assembly of the above mentioned kind in that a second outlet with shut-off means is provided for the connection with a heating circulation installation of the heating system, and a system disconnector is provided between the fresh water inlet and the second outlet for physically disconnecting the water supply from the heating circulation installation by means of two backflow preventers and a differential pressure controlled outlet valve arranged between the backflow preventers.

In such a way, only one fresh water connection is used for both the supply of fresh water in a drinking water heater and for the filling or re-filling of the heating circulation installation via a system disconnector. The fresh water inlet of the assembly provided for this purpose requires only one shut-off valve for the connection to the drinking water heater and the heating vessel filling when it is serviced. The assembly accordingly is less voluminous. A separation of the assemblies for filling and re-filling of the heating circulation installation is not necessary anymore.

In a preferred embodiment of the invention, a pressure reducer is provided which is adapted to adjust the water pressure at both outlets. The pressure reducer may be, for example, arranged directly behind the shut-off means at the fresh water inlet. It fulfills two functions: first, it secures a constant water pressure in the drinking water heater. A change of the hot water temperature at the tap points due to pressure variations is avoided. Secondly, the inlet pressure in the system disconnector and in the filling pipe of the heating circulation installation is kept at a constant level. Thereby the heating pressure is adjusted.

Due to the double function of the inlet side shut-off means and the pressure reducer, less components are required than using two separate assemblies. The assembly is, therefore, cheaper and smaller and it can be directly integrated into the heating system due to its small size.

In one embodiment of the invention, the second shut-off means for shutting off the connection to the heating circulation installation is a magnetic valve which is closed in the absence of electric power. The valve is closed even at a system break down. No water can pass into the heating circulation installation or into the opposite direction. Control and adjusting means can be provided for controlling the water flow in the heating circulation installation by means of the second shut-off means depending on the signal provided by a pressure sensor in the heating circulation installation. The pressure sensor provided in the heating system anyway may be used. Contrary to filling devices known in the art, there is no need for a separate pressure sensor. In such a way the automatic re-filling is possible in a very simple manner. The control provided in the heating system anyway can be programmed in such a way that it produces a control signal for the magnetic valve. If the pressure sensor in the heating circulation installation determines a low water pressure, the control signal is sent to the magnetic valve. The valve opens and water from the fresh water supply can flow into the heating circulation installation. If the pressure sensor produces a signal for a sufficient water pressure, the valve is closed again.

In a preferred embodiment of the invention the housing has an elongated shape thereby defining a longitudinal axis. The fresh water inlet and the first outlet are provided on the side of the housing. The backflow preventers are arranged inside the housing in alignment with the longitudinal axis of the housing and the housing is adapted to provide access to the backflow preventers through a socket at the end of the housing for servicing and testing. This arrangement is particularly compact and is especially suitable for the installation in heating systems present already. The assembly fulfills all requirements of EN1717 of a system disconnector.

Preferably the assembly has a housing provided with a heating circulation installation inlet forming a part of the heating circulation installation together with the second outlet. Shut-off means can be provided for shutting off the heating circulation installation between the heating circulation installation inlet and the second outlet. Such a shut-off means can be, for example, necessary for servicing. The shut-off means for shutting off the heating circulation insatllation may be a ball valve having a ball positioned in a volume between the heating circulation installation inlet and the second outlet, the volume being in fluid communication with the fresh water inlet through the second shut-off means and the system disconnector. Preferably a drain valve is provided for draining the heating circulation installation.

In a particularly preferred embodiment of the invention means are provided for monitoring the amount of water fed to the heating circulation installation and display means for displaying a problem, if the amount of water fed to the system is outside an admissible range. All required features of a heating circulation are integrated in one assembly. The assembly, however, is still very compact and can be directly integrated into a heating system with a drinking water heater.

An embodiment of the invention is described below in greater detail with reference to the accompanying drawings. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### BRIEF DESCRIPTION OF THE DRAWINGS

FIG. 1 is a top view of an assembly for feeding water to a heating system with a drinking water heater.

FIG. 2 is a side view of the assembly of FIG. 1 from the left side in FIG. 1.

FIG. 3 is a back view of the assembly of FIGS. 1 and 2 from the left side in FIG. 2.

FIG. 4 is a horizontal cross sectional view of the assembly of the FIGS. 1 to 3.

FIG. 5 is a vertical cross sectional view along the cutting line A-A in FIG. 4.

FIG. 6 is a vertical cross sectional view along the cutting line C-C in FIG. 4.

FIG. 7 is a vertical cross sectional view of an assembly with a system disconnector with test sockets.

### DESCRIPTION OF AN EMBODIMENT

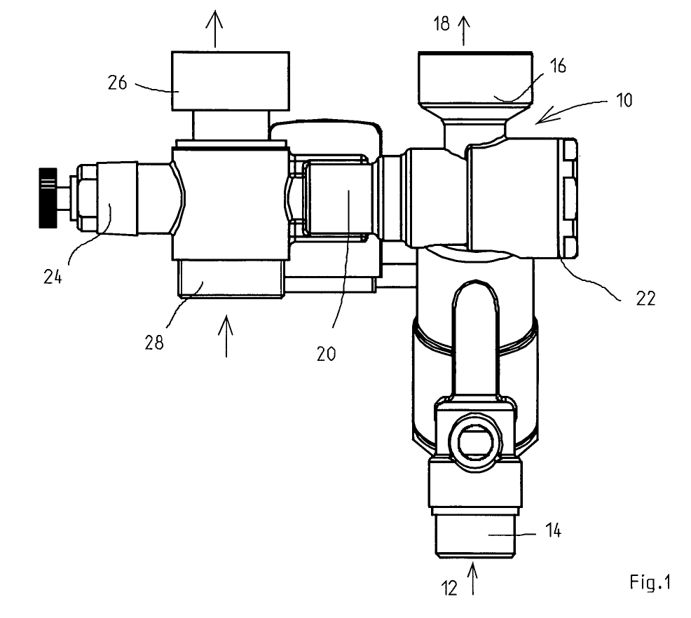

FIG. 1 shows an assembly generally denoted with numeral 10 for the connection of a heating system (not shown) to a drinking water supply. The drinking water supply is obtained from a drinking water network. The assembly 10 is connected to the drinking water network with an inlet in the form of an inlet socket 14. The water flows in the direction of the arrow 12.

Furthermore, the assembly has a first outlet in the form of an outlet socket 16. The outlet 16 is connected to a drinking water heater. The drinking water can flow in the direction of the arrow 18 from the outlet towards the drinking water heater (not shown). A gas boiler mounted to a wall is a used as a drinking water heater in this particular case.

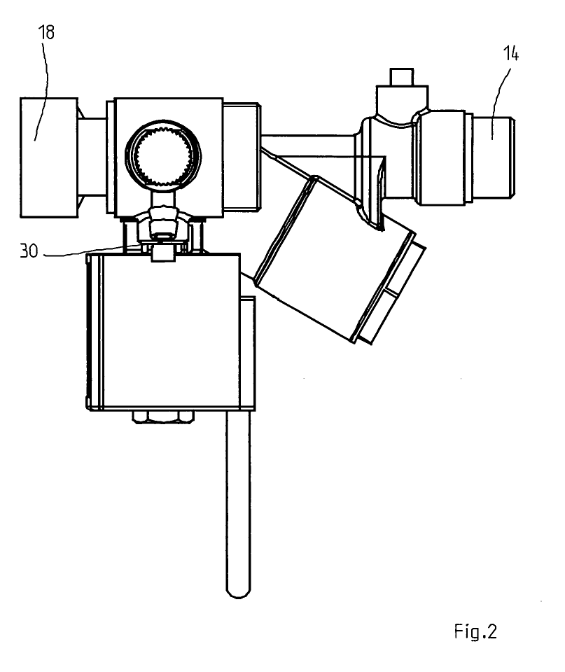

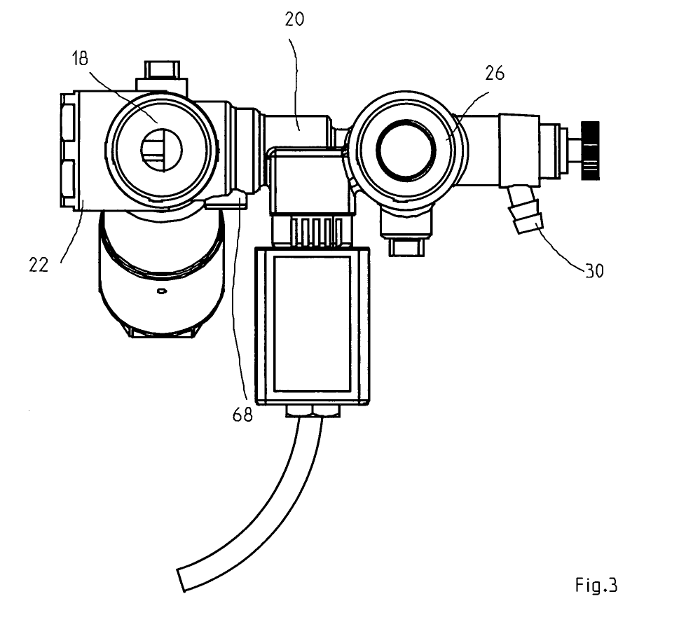

The assembly 10 comprises an elongated housing 20 with sockets 14 and 16 which are integrated into the housing under a right angle. At one of its endfaces the housing 20 is provided with an opening which is closed by a plug. A socket 26 which also defines a right angle with the housing 20 and which extends parallel to the outlet 16 forms the outlet for a heating circulation installation. A socket 28 in alignment with socket 26 form the inlet for the heating circulation installation. In the present case the assembly is positioned in the back flow of the heating circulation installation. An outlet 30 (FIG. 2 and FIG. 3) is provided for draining the heating circulation installation.

The assembly can be integrated into a heating system as a whole. The outlets 18 and 26 are positioned in such a way, and they have such outer diameters, that they can be connected easily to existing connections without the need of manipulating the heating system itself. The assembly, therefore, substitutes the separate components and connection parts for the heating circulation installation and the fresh water connection.

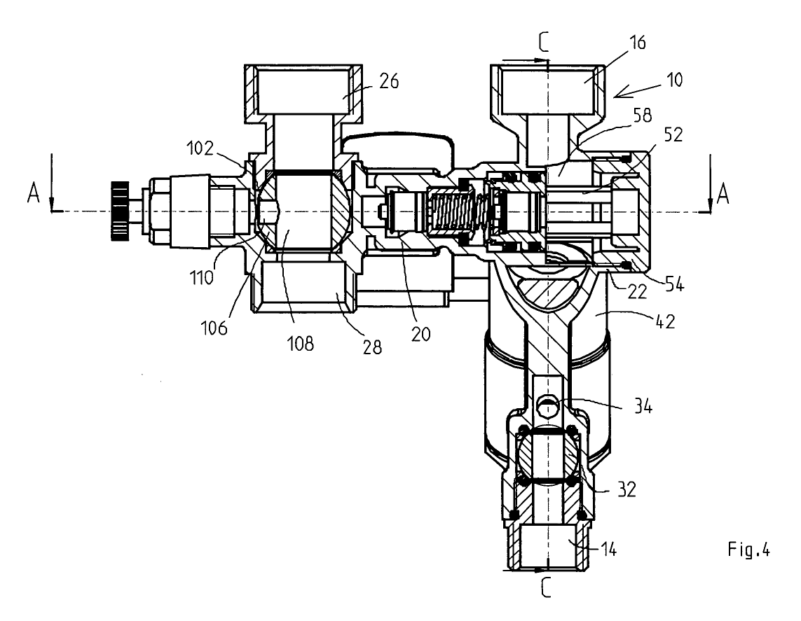

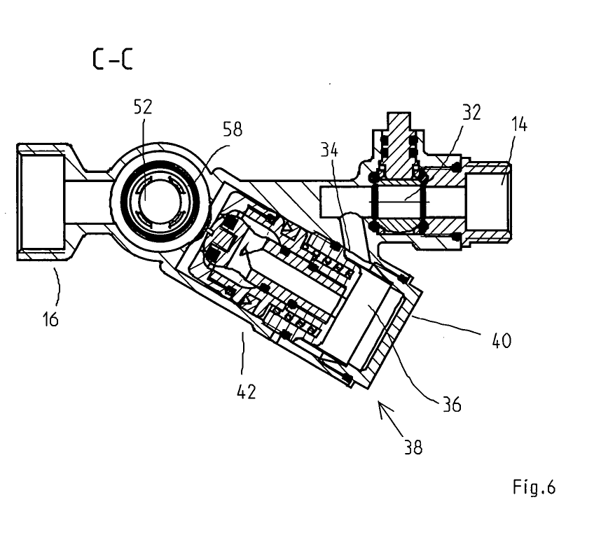

Referring now to FIG. 4 to FIG. 6, the features of the assembly 10 are now described in greater detail: Downstream behind the inlet 14 is a ball valve 32 provided. The inlet 14 can be shut off by the ball valve 32 by means of a tool (not shown). In FIG. 4 to FIG. 6 the ball valve is shown in an open position. The water flows through the ball valve 32 and afterwards downwards through a passage 34 (FIG. 4). The passage 34 ends in the inlet area 36 of a pressure reducer 38 integrated into the assembly. The pressure reducer 38 is in a housing portion 42 which is closed by a lid 40. Like a cartridge the pressure reducer 38 may be pulled out of the housing portion 42 for servicing. The pressure reducer 38 provides a constant inlet pressure for the following components.

The water flows from the pressure reducer 38 into a hollow space in the elongated housing portion 20. The hollow space 58 is connected to the outlet 16. The hollow space is accessible through a plug 54 with distance pieces in the form of webs. The water can directly flow from the inlet 14 through the pressure reducer 38 to the outlet 16. It is available there for the drinking water heating.

The elongated housing 20 defines a cylindrical chamber 70. The hollow space 58 is connected to this cylindrical chamber 70. A system disconnector with a differential pressure controlled outlet valve and two backflow preventers 62 and 64 is arranged therein.

The outlet valve 60 comprises a piston-shaped valve body 66. The valve body 66 is guided in the chamber 70. It closes an outlet 68 extending from the chamber 70 against the spring bias of a spring 72 if the inlet pressure is sufficiently high. The outlet 68 is provided with an outlet socket connected to the atmosphere.

The valve body 66 is sealingly guided in the cylindrical chamber 70 with a sealing 76 on its circumferential surface. An annular valve seat is formed by the valve body 66 on the downstream end face 78. The valve seat abuts the seat sealing 80 in its downstream end position (not shown). The valve body 66 covers the outlet 68 with the circumferential surface 74. This is the outlet valve.

The valve body 66 is provided with a central passage. An upstream backflow preventer 62 is arranged inside this passage. A valve seat is arranged in the housing of the backflow preventer. The valve seat cooperates with a valve closing body opening in a downstream direction against the pressure of a helical screw, if there is a sufficient inlet pressure.

The helical screw 72 is supported on a shoulder 82 on the inside of the housing 20 and abuts the downstream, backward side of the valve body 66. Thereby the valve body 66 of the outlet valve is biased by the spring 72. The spring 72 provides for the opening of the outlet valve in the absence of further forces.

Downstream of the described assembly a downstream backflow preventer 64 is arranged in the fitting housing. The backflow preventer 64 is principally similar to the upstream backflow preventer 62 and therefore not described in detail. Both backflow preventers only open in the direction from the inlet pressure to the outlet pressure. A middle pressure space 70 is formed between the valve body 66 and the upstream backflow preventer 64.

The helical screw of the backflow preventer 62 is stronger than the helical screw 72 acting on the valve body 66. Thereby the backflow preventer 62 opens only if the valve body 66 has been moved into its downstream end position due to the pressure difference between the inlet pressure and the middle pressure present in the middle pressure space.

If the passage towards the outlet socket is closed in such a way with respect to the outlet 68 and the atmosphere, the backflow preventers are pushed open by the water pressure. The heating system is filled up to an outlet pressure, which is slightly lower than the inlet pressure.

The outlet valve body 66 has a diameter on the inlet side corresponding to the inner diameter of the elongated housing 20. The outlet valve body 66 furthermore defines an annular step 84 in such a way that the downstream side has a smaller diameter.

The inlet pressure, therefore, acts on an area which is defined by the larger diameter. However, the seat sealing 80 and the downstream side of the outlet valve body 66, have a smaller diameter.

In the area of the smaller diameter of the outlet valve body there is a hollow space 86 between the outlet valve body 66 and the inside of the housing 20. A moveable valve seat 88 is guided in the hollow space 86. The moveable valve seat 88 has an L-shaped cross section. The moveable valve seat 88 is moveably guided in an axial direction. Furthermore a sealing ring 90 is provided in the hollow space 86. The hollow space 86 is hydraulically connected to the middle pressure chamber through a passage.

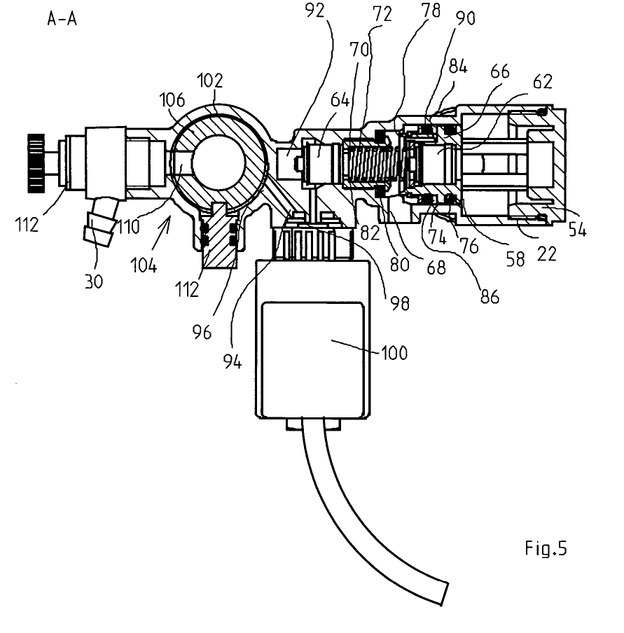

The middle pressure present in the middle pressure chamber is also present in the hollow space 86. If the outlet valve 68 is opened, as it is shown in FIG. 5, the middle pressure corresponds to the atmospheric pressure. If the outlet valve 68 is closed, the middle pressure increases with increasing inlet pressure. The moveable valve seat 76 moves towards the left in the figure.

If the inlet pressure is high with an open backflow preventer the outlet valve body 66 is in its left stop position against the spring power of the spring 72. The outlet valve is closed. The backflow preventer 62 is open. The middle pressure is also present in the hollow space 86. Due to the middle pressure the moveable valve seat 88 is moved to abut an annular shoulder in the fitting housing with one leg. The pressure in the hollow space 86, however, is exercised only on the backward, exceeding portion of the pressurising surface of the valve body 66. In such a way it is ensured that the effective area is the same for the middle pressure as for the inlet pressure. Thereby the forces on the valve body 66 remain independent of the inlet pressure.

The valve seat sealing 80 has a smaller diameter in the described assembly. As the forces on the valve body remain unchanged if the pressure conditions remain unchanged the pressing pressure on the seat sealing 80 is stronger. Thereby the sealing power is increased. This enables the realisation of a particularly small system disconnector with small diameters.

A hollow space 92 is defined in the housing 20 behind the downstream backflow preventer. The hollow space 92 is in fluid communication with the heating circulation installation through two passages 94 and 96. A common commercially available magnetic valve 98 which is closed in the absence of electric power is disposed between the passages 94 and 96. The magnetic valve 98 is controlled by a control and power supply unit 100. If a current flows through a coil of the magnetic valve, it is opened and the water can flow into the heating circulation installation.

The control and adjusting unit 100 receives the signal of the pressure sensor of the heating system disposed in the heating circulation installation. If the pressure drops below a minimum pressure, it opens automatically. The heating circulation installation is re-filled until a given set value is obtained. Then the magnetic valve is closed again. Furthermore, the control is programmed with a leakage protection. If the magnetic valve opens and closes very often in a selected period of time, i.e. if the pressure drops often, the magnetic valve is closed completely and a failure alarm is displayed (monitoring of the cycles). Furthermore, it is provided that the magnetic valve only opens for a maximum period of time and that a failure alarm is displayed also otherwise (run time monitoring). In such a way, it is ensured that no re-filling is carried out if there is a small or large leak in the heating circulation installation.

The passage 96 ends in the outer space 102 of the ball valve 104. The ball valve 104 is arranged between the inlet 28 and the outlet 26 provided for the heating circulation installation. FIG. 4 shows the ball valve 104 in an open state, i.e., the passage 108 of the ball 106 is in alignment with the inlet 28 and the outlet 26. For filling the heating circulation installation, the passage 96 is in fluid communication with the passage 108 through the passage 110 in the ball 106. Water may, therefore, flow from the passage 96 through the passage 110 and then into the heating circulation installation. For filling or re-filling of the heating circulation installation, the shut-off valve 32 and the magnetic valve 98 are opened.

For draining the heating circulation installation, the ball valve 104 is rotated into a closed position by means of a tool engaged as an activating means 112. The passage 110 is then in alignment with the inlet 28. Then the outlet valve 112 is opened and the heating circulation installation can be drained through the passage 110 and the outlet 30.

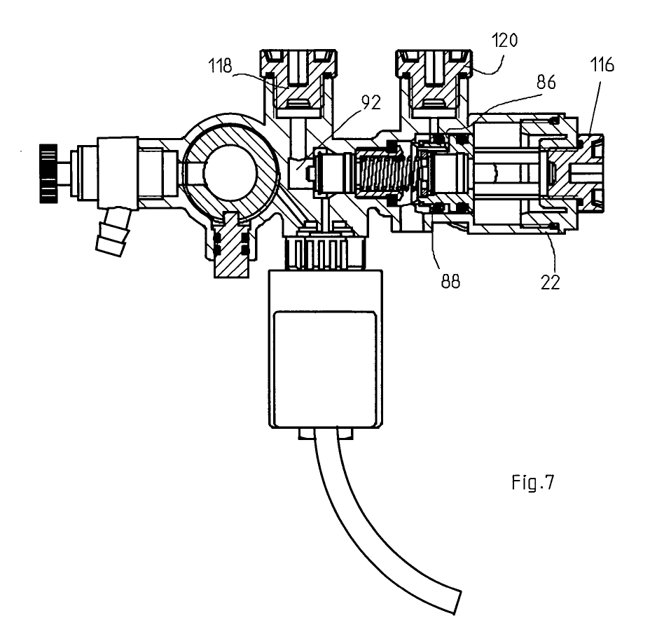

FIG. 1 to FIG. 6 show an assembly which is provided with a type CA system disconnector. For higher risk categories it may be necessary to use a type BA system disconnector due to legal regulations. Such a system disconnector is provided with test sockets allowing the checking of the inlet pressure, the pressure in the middle pressure chamber, and the outlet pressure. An example of an assembly with test sockets is shown in FIG. 7 which corresponds to FIG. 5.

The inlet pressure can be determined through a test socket 116 at the opening 22. The measurement of the outlet pressure downstream of the backflow preventers can be taken at a test socket 118 which is connected to the hollow space 92. For measuring the pressure in the middle pressure chamber 70, a test socket can be provided directly at the middle pressure chamber 70. However, this is difficult, because sealings have to be used again. Therefore, the present embodiment makes use of a variation which is simpler and preferred. The test socket 120 is connected to the hollow space 86 behind the moveable valve seat 88. As the hollow space is connected to the middle pressure space through a passage, there is also middle pressure there.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. An assembly (10) for feeding water from a water supply into heating systems, said heating systems comprising a drinking water heater and a heating circulation installation, the assembly comprising:
a fresh water inlet (14) adapted to be connected to said water supply, an inlet pressure being present in said fresh water inlet (14);
a first outlet (16) adapted to be connected to a water heater; and
first shut-off means (32) for shutting off a water flow from said water supply through said fresh water inlet;
a second outlet (26) adapted to be connected to said heating circulation installation of said heating system, an outlet pressure being present in said second outlet (26);
second shut-off means (98), said second shut-off means provided at said second outlet (26);
two backflow preventers (62, 64) disposed between said fresh water inlet (14) and said second outlet (26), defining a middle pressure chamber therebetween having a middle pressure chamber; and
a differential pressure controlled outlet valve (60) arranged between said backflow preventers, thereby forming a system disconnector adapted to physically disconnect the water supply from the heating circulation installation.

2. An assembly according to claim 1, wherein a pressure reducer (38) is provided which is adapted to adjust a water pressure at said first and said second outlet (16, 26).

3. An assembly according to claim 1, wherein the second shut-off means (98) is a magnetic valve which is closed in the absence of electric power.

4. An assembly according to claim 1, and further comprising control and adjusting means (100) to control a water flow in said heating circulation installation, said means comprising:
a pressure sensor disposed in said heating circulation installation, said pressure sensor adapted to generate a signal representing the water pressure in said heating circulation installation;
signal processing means for processing said signal, thereby generating a control signal; and
signal receiving means in said second shut-off means for receiving said control signal to control said second shut-off means.

5. An assembly according to claim 1, wherein
a housing (20) with an elongated shape is provided, said housing defining a longitudinal axis, a side, and an end face, a socket (22) being provided at said end face;
said fresh water inlet (14) and said first outlet (16) are provided on said side of said housing,
said backflow preventers (62, 64) are arranged inside said housing (20) in alignment with said longitudinal axis; and
said housing is adapted to provide access to said backflow preventers through said socket (22) for servicing and testing.

6. An assembly according to claim 1, wherein said housing is provided with a heating circulation installation inlet (28), said heating circulation installation inlet forming a part of said heating circulation installation together with said second outlet (26).

7. An assembly according to claim 6, wherein third shut-off means (104) are provided for shutting off said heating circulation installation between said heating circulation installation inlet (28) and said second outlet (26).

8. An assembly according to claim 7, wherein said third shut-off means for shutting off said heating circulation installation is a ball valve (104) having a ball (106) positioned in a volume between said heating circulation installation inlet (28) and said second outlet (26), said volume being in fluid communication with said fresh water inlet (14) through said second shut-off means and said system disconnector.

9. An assembly according to claim 8, wherein a drain valve (30) is provided for draining said heating circulation installation.

10. Assembly according to claim 1, wherein means are provided for monitoring the amount of water fed to said heating circulation installation and display means for displaying a problem, if the amount of water fed to said system is outside an admissible range.
